(19) United States
(12) Patent Application Publication
(10) Pub. No.: US 2007/0082529 A1
(43) Pub. Date: Apr. 12, 2007

(54) Die pickup apparatus, method for using the same and die pickup method

(75) Inventors: Hideji Nishio, Kodaira-shi (JP); Yasushi Sato, Higashiyamato-shi (JP); Shinichi Sasaki, Higashiyamato-shi (JP); Yutaka Odaka, Akiruno-shi (JP); Takashi Nobe, Sayama-shi (JP)

Correspondence Address: KODA & ANDROLIA, 2029 CENTURY PARK EAST, SUITE 1140, LOS ANGELES, CA, 90067, US

(73) Assignee: Kabushiki Kaisha Shinkawa

(21) Appl. No.: 11/546,060

(22) Filed: Oct. 11, 2006

(30) Foreign Application Priority Data
Oct. 11, 2005 (JP) 2005-295810

(51) Int. Cl. H01R 11/22

(52) U.S. Cl. 439/266

(57) ABSTRACT

A die pickup apparatus including a wafer sheet push-up unit provided inside a suction stage that suction-holds a wafer sheet having thereon dies. The wafer sheet push-up unit is made of push-up members, and the inner most push-up member is connected to a linking up-and-down moving shaft, so that when the linking up-and-down moving shaft is raised, the outer most push-up member in contact with the linking up-and-down moving shaft is raised, raising telescopically the inner push-up members. The outermost push-up member has a stopper that is adjustable in its up-and-down positions and comes into contact with the suction stage to stop the rising motion of the outermost push-up member, and the next inner side push-up member has its own stopper that is adjustable in its up-and-down positions and comes into contact with the outermost push-up member to stop the rising motion of the intermediate push-up member.

### BACKGROUND OF THE INVENTION

The present invention relates to a die pickup apparatus and more particularly to a die pickup apparatus for individually picking up, from a wafer sheet, dies lined up on and affixed to the wafer sheet.

Die pickup apparatuses that successively peel a wafer sheet away from the outer circumferential side of a die are disclosed in, for instance, Japanese Patent Application Laid-Open Document (2003) No. 2003-133391 and (2005) No. 2005-117019.

The wafer sheet push-up unit disclosed in Japanese Patent Application Laid-Open Document (2003) No. 2003-133391 includes has a plurality of ring-shaped push-up members disposed successively from the outside toward the inside. Each of the plurality of push-up members is formed in a stepped shape having a shoulder and is held by a push-up member on their outsides. The plurality of push-up members are moved up and down by a cam having cam portions that correspond to the plurality of push-up members. The push-up members are made to rise, beginning with the most outside push-up member, successively, and lastly the inside push-up member, by the cams, from the outside cam, successively, to the inside cam. As a result, the wafer sheet is successively peeled away from the outer circumferential side of the die.

On the other hand, in the wafer sheet push-up unit of Japanese Patent Application Laid-Open Document (2005) No. 2005-117019, three ring-shaped push-up members are disposed successively from the outside suction stage (suction piece) toward the inside. A first compression coil spring is provided between the outside push-up member and the intermediate push-up member, and a second compression coil spring having a larger spring constant than the first compression coil spring is provided between the intermediate push-up member and the inside push-up member; and the inside push-up member, linked with an up-and-down moving shaft, is provided so as to be movable up and down. In this structure, the rising of the outside push-up member is stopped by a part of the push-up member contacting the suction stage, the rising of the intermediate push-up member is stopped by a part of the push-up member contacting the outside push-up member, and the inside push-up member is controlled by the rising of the up-and-down moving shaft.

In the above-described structure, when the up-and-down moving shaft is raised and pushes the inside push-up member up, the intermediate push-up member is pushed up by the spring force of the second compression coil spring provided between the inside push-up member and the intermediate push-up member, and, further, the outside push-up member is pushed up by the spring force of the first compression coil spring provided between the outside push-up member and the intermediate push-up member; as a result, the three push-up members are pushed up simultaneously. Then, the rising of the three push-up members is stopped by a part of the outside push-up member contacting the upper inner surface of the suction stage. When the up-and-down moving shaft is raised further, then due to the second compression coil spring provided between the intermediate push-up member and the inside push-up member, a part of the intermediate push-up member contacts the outside push-up member, and the rising of the intermediate and inside push-up members stops. In this case, because the spring force of the first compression coil spring is smaller than the spring force of the second compression coil spring, the intermediate push-up member can rise until it contacts the upper inner surface of the outside push-up member. When the up-and-down moving shaft is raised further, only the inside push-up member is raised. As a result, the wafer sheet is successively peeled away from the outer circumferential side of the die.

In the wafer sheet push-up unit of Japanese Patent Application Laid-Open Document (2003) No. 2003-133391, the amount of rise of the plurality of push-up members is determined by a cam mechanism having cams corresponding to the plurality of push-up members. For this reason, for die size changes, wafer sheet changes, and variations over time, it is necessary that the cams be replaced with those corresponding thereto.

In the wafer sheet push-up unit of Japanese Patent Application Laid-Open Document (2005) No. 2005-117019, the rise of the outside push-up member and of the intermediate push-up member is stopped by a part of the outside push-up member contacting the suction stage and/or a part of the intermediate push-up member contacting the outside push-up member. Thus, the amount of rise of the outside push-up member is determined by the gap between the suction stage and the outside push-up member, and the amount of rise of the intermediate push-up member is determined by the gap between the outside push-up member and the intermediate push-up member. Accordingly, for die size changes, wafer sheet changes, and variations over time, it is not possible to optimally set the plurality of push-up members to an optimal amount of rise.

### BRIEF SUMMARY OF THE INVENTION

Accordingly, the object of the present invention is to provide a die pickup apparatus that allows easy setting of an optimal amount of rise of a plurality of push-up members in response to die size changes, wafer sheet changes, and variations over time.

The above object is accomplished by a unique structure of the present invention for a die pickup apparatus that includes:
a suction stage for suction-holding the lower surface of a wafer sheet having dies lined up and affixed thereon;
a wafer sheet push-up unit provided inside the suction stage, the wafer sheet push-up unit including a plurality of push-up members disposed successively from outer side to inner side of the suction stage;
an up-and-down drive unit for driving the wafer sheet push-up unit in the direction of up and down, the up-and-down drive unit having an up-and-down moving drive shaft;
an outermost push-up stopper being screwed into the outer circumference of an outermost push-up member of the push-up members;
a step for contacting the outermost push-up stopper to stop the rising motion of the outermost push-up member, being provided opposite to the outermost push-up stopper on the inner surface of the suction stage; and
a plurality of intermediate push-up stoppers for contacting each one of the push-up members located immediately outside each one of a plurality of intermediate push-up members to stop the rising motion of each one of the intermediate push-up members, being provided adjustably in the up-and-down position on the intermediate push-up members disposed between the outermost push-up member and an innermost push-up member of the push-up members.

The above-described object is accomplished also by unique steps of the present invention for a die pickup method that uses a die pickup apparatus, and the unique steps include:
providing a die pickup apparatus, the die pickup apparatus comprising:
   a suction stage for suction-holding the lower surface of a wafer sheet having dies lined up and affixed thereon,
   a wafer sheet push-up unit provided inside the suction stage, the wafer sheet push-up unit including a plurality of push-up members disposed successively from outer side to inner side of the suction stage,
   an up-and-down drive unit for driving the wafer sheet push-up unit in the direction of up and down, the up-and-down drive unit having an up-and-down moving drive shaft,
   an outermost push-up stopper being screwed into the outer circumference of an outermost push-up member of the push-up members,
   a step for contacting the outermost push-up stopper to stop the rising motion of the outermost push-up member, being provided opposite to said outermost push-up stopper on an inner surface of the suction stage, and
   a plurality of intermediate push-up stoppers for contacting each one of the push-up members located immediately outside each one of a plurality of intermediate push-up members to stop the rising motion of each one of the intermediate push-up members, being provided adjustably in the up-and-down position on the intermediate push-up members disposed between the outermost push-up member and an innermost push-up member of the push-up members;
linking the innermost push-up member of the push-up members to the up-and-down moving drive shaft;
simultaneously raising all of the push-up members by raising the up-and-down moving drive shaft; and then
sequentially further raising the push-up members from one of the push-up members located immediately inside the outermost push-up member to the innermost push-up member, thus the wafer sheet being peeled away successively from a die from the outer circumferential side of the die toward the center of the die by means of the push-up members.

The above-described object is accomplished by further unique steps of the present invention for a die pickup method, and the unique steps include:
providing a suction stage for suction-holding the lower surface of a wafer sheet having dies lined up and affixed thereon;
providing a wafer sheet push-up unit disposed inside the suction stage, the wafer sheet push-up unit including a plurality of push-up members disposed successively from outer side to inner side of the suction stage;
providing an up-and-down drive unit for driving the wafer sheet push-up unit in the direction of up and down, the up-and-down drive unit having an up-and-down moving drive shaft;
providing an outermost push-up stopper being screwed into the outer circumference of an outermost push-up member of the push-up members;
providing a step for contacting the outermost push-up stopper to stop the rising motion of the outermost push-up member, being disposed opposite to the outermost push-up stopper on the inner surface of the suction stage;
providing a plurality of intermediate push-up stoppers for contacting each one of the push-up members located immediately outside each one of a plurality of intermediate push-up members to stop the rising motion of each one of the intermediate push-up members, being disposed adjustably in the up-and-down position on the intermediate push-up members disposed between the outermost push-up member and an innermost push-up member of the plurality of push-up members;
linking the innermost push-up member of the push-up members to the up-and-down moving drive shaft;
simultaneously raising all of the push-up members by raising the up-and-down moving drive shaft; and then
sequentially further raising the push-up members from one of the push-up members located immediately inside the outermost push-up member to the innermost push-up member, thus the wafer sheet being peeled away successively from a die from the outer circumferential side of the die toward the center of the die by means of the push-up members.

The above object is accomplished by another unique structure of the present invention for a die pickup apparatus that includes:
a suction stage for suction-holding the lower surface of a wafer sheet having dies lined up and affixed thereon;
a wafer sheet push-up unit provided inside the suction stage, the wafer sheet push-up unit including three push-up members having a first stage push-up member, a second stage push-up member, and a third stage push-up member, disposed successively from outer side to inner side of the suction stage;
an up-and-down drive unit for driving the wafer sheet push-up unit in the direction of up and down, the up-and-down drive unit having an up-and-down moving drive shaft;
a first stage stopper for contacting the outer circumference of the first stage push-up member to stop the rising motion of the first stage push-up member, being provided adjustably in the up-and-down position on the first stage push-up members;
a linking stopper disposed between a bottom surface of the second stage push-up member and an inner bottom surface of the first stage push-up member, and for maintaining a space therebetween;
a stopper shaft provided on the bottom of the second stage push-up member by passing through the bottom of the first stage push-up member;
a second stage stopper for stopping rising motion of the second stage push-up member, being provided adjustably in the up-and-down position on the stopper shaft;
a linking up-and-down moving shaft being secured to the third stage push-up member, extending downward through the second stage push-up member and the first stage push-up member, and being linked to the up-and-down moving drive shaft;
a first stage holding compression spring being provided on the lower surface side of the first stage push-up member, for biasing power against the first stage push-up member upward; and
a second stage holding compression spring being disposed in the space between the first stage push-up member and the second stage push-up member, for biasing power against the second stage push-up member upward.

The above-described object is accomplished also by unique steps of the present invention for a die pickup method using a die pickup apparatus, and the unique steps include:
providing a die pickup apparatus, the die pickup apparatus comprising:
   a suction stage for suction-holding the lower surface of a wafer sheet having dies lined up and affixed thereon,
   a wafer sheet push-up unit provided inside the suction stage, the wafer sheet push-up unit including three push-up members having a first stage push-up member, a second stage push-up member, and a third stage push-up member, disposed successively from outer side to inner side of the suction stage,
   an up-and-down drive unit for driving the wafer sheet push-up unit in the direction of up and down, the up-and-down drive unit having an up-and-down moving drive shaft,
   a first stage stopper for contacting the outer circumference of the first stage push-up member to stop rising motion of the first stage push-up member, being provided adjustably in the up-and-down position on the first stage push-up member;
   a linking stopper disposed between a bottom surface of the second stage push-up member and an inner bottom surface of the first stage push-up member, and for maintaining a space therebetween,
   a stopper shaft provided on the bottom of the second stage push-up member by passing through the bottom of the first stage push-up member,
   a second stage stopper for stopping rising motion of the second stage push-up member, being provided adjustably in the up-and-down position on the stopper shaft,
   a linking up-and-down moving shaft being secured to the third stage push-up member, extending downward through the second stage push-up member and the first stage push-up member, and being linked to the up-and-down moving drive shaft,
   a first stage holding compression spring being provided on the lower surface side of the first stage push-up member, for biasing power against the first stage push-up member upward, and
   a second stage holding compression spring being disposed in the space between the first stage push-up member and the second stage push-up member, for biasing power against the second stage push-up member upward;
linking the third stage push-up member to the up-and-down moving drive shaft;
simultaneously raising all of the push-up members by raising the up-and-down moving drive shaft;
further raising the second stage push-up member and the third stage push-up member; and
lastly further raising the third stage push-up member, thus the wafer sheet being peeled away successively from a die from the outer circumferential side of the die toward the center of the die by means of the push-up members.

The above-described object is accomplished by further unique steps of the present invention for a die pickup method, and the unique steps include:
providing a suction stage for suction-holding the lower surface of a wafer sheet having dies lined up and affixed thereon;
providing a wafer sheet push-up unit installed inside the suction stage, the wafer sheet push-up unit including three push-up members having a first stage push-up member, a second stage push-up member, and a third stage push-up member, disposed successively from outer side to inner side of the suction stage;
providing an up-and-down drive unit for driving the wafer sheet push-up unit in the direction of up and down, the up-and-down drive unit having an up-and-down moving drive shaft;
providing a first stage stopper for contacting the outer circumference of the first stage push-up member to stop rising motion of the first stage push-up member, being disposed adjustably in the up-and-down position on the first stage push-up member;
providing a linking stopper disposed between a bottom surface of the second stage push-up member and an inner bottom surface of the first stage push-up member, and for maintaining a space therebetween;
providing a stopper shaft provided on the bottom of the second stage push-up member by passing through the bottom of the first stage push-up member;
providing a second stage stopper for stopping rising motion of the second stage push-up member, being provided adjustably in the up-and-down position on the stopper shaft,
providing a linking up-and-down moving shaft being secured to the third stage push-up member, extending downward through the second stage push-up member and the first stage push-up member, and being linked to the up-and-down moving drive shaft;
providing a first stage holding compression spring being disposed on the lower surface side of the first stage push-up member, for biasing power against the first stage push-up member upward;
providing a second stage holding compression spring being disposed in the space between the first stage push-up member and the second stage push-up member and for biasing power against the second stage push-up member upward;
linking the third stage push-up member to the up-and-down moving drive shaft;
simultaneously raising all of the push-up members by raising the up-and-down moving drive shaft;
further raising the second stage push-up member and the third stage push-up member; and
lastly further raising the third stage push-up member, thus the wafer sheet being peeled away successively from a die from the outer circumferential side of the die toward the center of the die by means of the push-up members.

The above object is accomplished by still another unique structure of the present invention for a die pickup apparatus that includes:
a suction stage for suction-holding the lower surface of a wafer sheet having dies lined up and affixed thereon;
a wafer sheet push-up unit provided inside the suction stage, the wafer sheet push-up unit including three push-up members having a first stage push-up member, a second stage push-up member, and a third stage push-up member, disposed successively from outer side to inner side of the suction stage;
an up-and-down drive unit for driving the wafer sheet push-up unit in the direction of up and down, the up-and-down drive unit having an up-and-down moving drive shaft;
a first stage stopper for contacting the outer circumference of the first stage push-up member to stop rising motion of the first stage push-up member, being provided adjustably in the up-and-down position on the first stage push-up member;
a stopper supporting shaft for passing through the first stage push-up member, being secured to the second stage push-up member;
a ring-shaped second stage stopper supporting plate being secured to the stopper supporting shaft;
a second stage stopper for contacting the second stage stopper supporting plate to stop the rising motion of the second push-up member, being provided adjustably in the up-and-down position on the first stage push-up member and being also provided relative to the second stage stopper supporting plate;
a first stage compression spring holding block being provided movably in the direction of up and down with supporting the stopper supporting shaft on a lower end thereof;
a linking up-and-down moving shaft being secured to the third stage push-up member, the linking up-and-down moving shaft extending downward through the first stage push-up member, and being linked to the up-and-down moving drive shaft;
a positioning piece being secured to the linking up-and-down moving shaft and being provided in a portion on a bottom surface of the first stage push-up member;
a first stage holding compression spring being provided between the first stage compression spring holding block and the first stage push-up member, for biasing power against the first stage push-up member upward; and
a second stage holding compression spring being provided between the positioning piece and the second stage push-up member, for biasing power against the second stage push-up member upward.

The above-described object is accomplished by unique steps of the present invention for a die pickup method that uses a die pickup apparatus, and the unique steps include:
providing a die pickup apparatus, the die pickup apparatus comprising:
   a suction stage for suction-holding the lower surface of a wafer sheet having dies lined up and affixed thereon,
   a wafer sheet push-up unit provided inside the suction stage, the wafer sheet push-up unit including three push-up members having a first stage push-up member, a second stage push-up member, and a third stage push-up member, disposed successively from outer side to inner side of the suction stage,
   an up-and-down drive unit for driving the wafer sheet push-up unit in the direction of up and down, the up-and-down drive unit having an up-and-down moving drive shaft,
   a first stage stopper for contacting the outer circumference of the first stage push-up member to stop rising motion of the first stage push-up member, the first stage stopper being provided adjustably in the up-and-down position on the first stage push-up member,
   a stopper supporting shaft for passing through the first stage push-up member, being secured to the second stage push-up member,
   a ring-shaped second stage stopper supporting plate being secured to the stopper supporting shaft,
   a second stage stopper for contacting the second stage stopper supporting plate to stop the rising motion of the second stage push-up member, being provided adjustably in the up-and-down position on the first stage push-up member and being also disposed relative to the second stage stopper supporting plate,
   a first stage compression spring holding block being provided movably in the direction of up and down with supporting the stopper supporting shaft on a lower end thereof,
   a linking up-and-down moving shaft being secured to the third stage push-up member, the linking up-and-down moving shaft extending downward through the first stage push-up member, and being linked to the up-and-down moving drive shaft,
   a positioning piece being secured to the linking up-and-down moving shaft and being provided in a portion on a bottom surface of the first stage push-up member,
   a first stage holding compression spring being provided between the first stage compression spring holding block and the first stage push-up member, for biasing power against the first stage push-up member upward, and
   a second stage holding compression spring being provided between the positioning piece and the second stage push-up member, for biasing power against the second stage push-up member upward;
linking the third stage push-up member to the up-and-down moving drive shaft;
simultaneously raising all of the push-up members by raising the up-and-down moving drive shaft;
further raising the second stage push-up member and the third stage push-up member; and
lastly further raising the third stage push-up member, thus the wafer sheet being peeled away successively from a die from the outer circumferential side of the die toward the center of the die by means of the push-up members.

The above-described object is accomplished by further unique steps of the present invention for a die pickup method, and the unique steps include:
providing a suction stage for suction-holding the lower surface of a wafer sheet having dies lined up and affixed thereon;
providing a wafer sheet push-up unit installed inside the suction stage, the wafer sheet push-up unit including three push-up members having a first stage push-up member, a second stage push-up member, and a third stage push-up member, disposed successively from outer side to inner side of the suction stage;
providing an up-and-down drive unit for driving the wafer sheet push-up unit in the direction of up and down, the up-and-down drive unit having an up-and-down moving drive shaft;
providing a first stage stopper for contacting the outer circumference of the first stage push-up member to stop rising motion of the first stage push-up member, the first stage stopper being disposed adjustably in the up-and-down position on the first stage push-up member;
providing a stopper supporting shaft for passing through the first stage push-up member, being secured to the second stage push-up member;
providing a ring-shaped second stage stopper supporting plate being secured to the stopper supporting shaft;
providing a second stage stopper for contacting the second stage stopper supporting plate to stop the rising motion of the second stage push-up member, being disposed adjustably in the up-and-down position on the first stage push-up member and being also disposed relative to the second stage stopper supporting plate;
providing a first stage compression spring holding block being disposed movably in the direction of up and down with supporting the stopper supporting shaft on a lower end thereof;
providing a linking up-and-down moving shaft being secured to the third stage push-up member, the linking up-and-down moving shaft extending downward through the first stage push-up member, and being linked to the up-and-down moving drive shaft;
providing a positioning piece being secured to the linking up-and-down moving shaft and being provided in a portion on a bottom surface of the first stage push-up member;
providing a first stage holding compression spring being provided between the first stage compression spring holding block and the first stage push-up member, the first stage holding compression spring for biasing power against the first stage push-up member upward;
providing a second stage holding compression spring disposed between the positioning piece and the second stage push-up member, the second stage holding compression spring for biasing power against the second stage push-up member upward;
linking the third stage push-up member to the up-and-down moving drive shaft;
simultaneously raising all of the push-up members by raising the up-and-down moving drive shaft;
further raising the second stage push-up member and the third stage push-up member; and
lastly further raising the third stage push-up member, thus the wafer sheet being peeled away successively from a die from the outer circumferential side of the die toward the center of the die by means of the push-up members.

In the above-described die pickup apparatus of the present invention, except for the innermost push-up member, a stopper, which contacts the suction stage to stop the rising motion of the outermost push-up member, is provided on the outermost push-up member in a manner that the up-and-down position of the stepper is adjustable; and in the other push-up members, stoppers, which contact the push-up member outside those push-up members to stop the other push-up members, are provided, respectively, so that the up-and-down positions of such stoppers are adjustable. Accordingly, in the present invention, by moving the respective stoppers up and down (or by adjusting the vertical position of the respective stoppers), the amount of rise of the respective push-up members is adjusted. As a result, for die size changes, wafer sheet changes, and variations over time, the amounts of rise of the push-up members can be adjusted, respectively, to the optimal conditions.

### BRIEF DESCRIPTION OF THE SEVERAL VIEWS OF THE DRAWINGS

FIG. 1(a) is a cross sectional view of a die pickup apparatus according to one embodiment of the present invention, FIG. 1(b) being a top view thereof;

FIGS. 2(a), 2(b) and 2(c) are cross-sectional views that show the operation of the die pickup apparatus of FIG. 1(a), following the initial operation of FIG. 1(a);

FIG. 3(a) is a cross sectional view of a die pickup apparatus according to another embodiment of f the present invention, 3(b) being a cross-sectional view taken along the lines 3b-3b in 3(a); and

FIGS. 4(a), 4(b) and 4(c) are cross-sectional views that show the operation of the die pickup apparatus of FIG. 3(a), following the initial operation of FIG. 3(a).

### DETAILED DESCRIPTION OF THE INVENTION

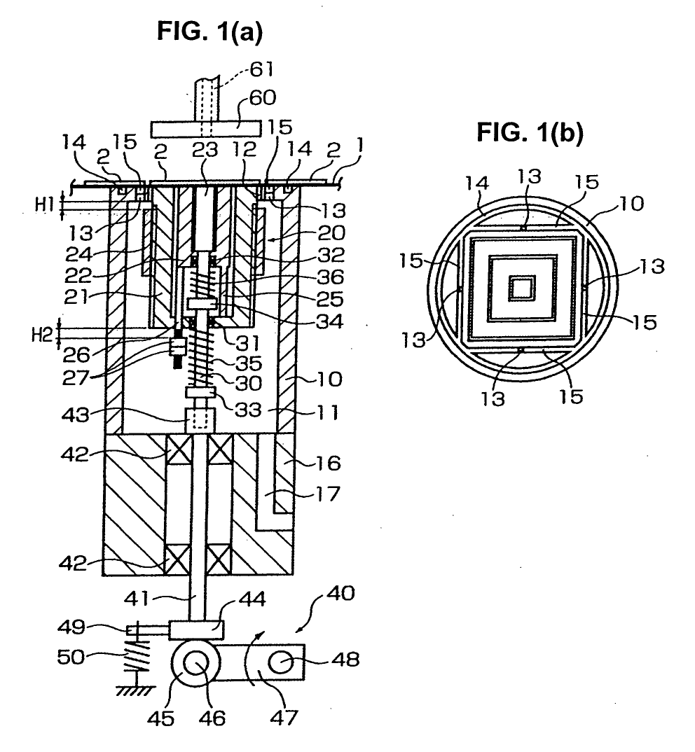

One embodiment of the die pickup apparatus of the present invention will be described below with reference to FIGS. 1(a) and 1(b).

A plurality of dies 2 are lined up and affixed to a wafer sheet 1. On the lower surface side of the wafer sheet 1, a suction stage 10 for suction-holding the wafer sheet 1 is provided, and a wafer sheet push-up unit 20 is provided inside the suction stage 10. Below the suction stage 10, an up-and-down drive unit 40 for driving the wafer sheet push-up unit 20 up and down is provided. Above the suction stage 10 (or the dies 2 on the stage 10), a suction head 60 for suction-holding the dies 2 and moving them is provided. A suction hole 61 is formed in the suction head 60.

First, the structure of the suction stage 10 will be described.

The suction stage 10 has an empty space 11 inside, and a ring-shaped push-up member opening 12 is formed at the top to be the center. As best seen from FIG. 1(b), a plurality of sheet suction holes 13 are formed on the outside of the push-up member opening 12. On the upper surface of the suction stage 10, a ring-shaped channel 14 is formed, and communicating channels 15 are formed so that the ring-shaped channel 14 communicates with the sheet suction holes 13. With the ring-shaped channel 14 and communicating channels 15, the portion of the wafer sheet 1 that is outside the dies 2 is securely suction-held to the suction stage 10. The suction stage 10 is secured to a suction stage support block 16, and a vacuum suction hole 17 is formed in the suction stage support block 16 so that the empty space 11 communicates with the outside of suction stage 10. One end of a vacuum pipe (not shown) is connected to the vacuum suction hole 17, and the other end of which is connected to a vacuum pump.

The structure of the wafer sheet push-up unit 20 will be described below.

The wafer sheet push-up unit 20 is provided in the empty space 11 inside of the suction stage 10 so that the upper end of the wafer sheet push-up unit 20 is exposed from the push-up member opening 12 of the suction stage 10. The wafer sheet push-up unit 20 is comprised of a first stage push-up member 21, a second stage push-up member 22, and a third stage push-up member 23 that are disposed successively from the outer side to the inner side of the suction stage 10. In other words, the first stage push-up member 21 is inside the suction stage 10, the second stage push-up member 22 is inside the first stage push-up member 21, and the third stage push-up member 23 is inside the second stage push-up member 22. The top end surfaces (that form die pressing surfaces) and the horizontal cross-sections of the first, second, and third stage push-up members 21, 22, and 23 are formed in square shapes as indicated in FIG. 1(b).

The first stage push-up member 21 is as seen from FIG. 1(a) positioned outermost, and its vertical cross-section has a concavity shape; and a first stage stopper 24 is screwed into the outer circumference of this first stage push-up member 21.

The second stage push-up member 22 is provided inside the first stage push-up member 21, with its vertical cross-section having a concavity shape as well.

The second stage push-up member 22 has, on its lower surface, a linking stopper 25 so that a certain space is maintained from the bottom surface of the first stage push-up member 21. The second stage push-up member 22 is provided so that its upper surface is in the same plane as the upper surface of the first stage push-up member 21 when the lower end of the linking stopper 25 is in contact with the bottom surface of the first stage push-up member 21. On the lower surface of the second stage push-up member 22, moreover, a stopper shaft 26 is secured so that it passes through the bottom surface of the first stage push-up member 21 and so that it functions both as a rotation arrester and as a stopper support. Nuts 27 are screw-engaged with the lower end of the stopper shaft 26. The nuts 27 constitute a second stage stopper.

The third stage push-up member 23 is provided inside the second stage push-up member 22; and the third stage push-up member 23 is provided so that its the upper surface is in the same plane as the upper surfaces of the first and second stage push-up members 21 and 22, when the lower end of the third stage push-up member 23 is in contact with bottom surface of the concavity of the second stage push-up member 22. To the third stage push-up member 23 is secured a linking up-and-down moving shaft 30 that extends downward so as to pass through the second stage push-up member 22 and the first stage push-up member 21. This linking up-and-down moving shaft 30 is provided so that it can freely rotate via bearings 31 and 32, respectively, in the first stage push-up member 21 and the second stage push-up member 22.

To the linking up-and-down moving shaft 30, spring force adjustment pieces 33 and 34 are secured. The spring force adjustment piece 33 is in the portion downward from the first stage push-up member 21, and the spring force adjustment piece 34 is in the portion upward from the bottom surface of the first stage push-up member 21, respectively.

Furthermore, on the linking up-and-down moving shaft 30, a first stage holding compression coil spring 35 and a second stage holding compression coil spring 36 are provided. The first stage holding compression coil spring 35 is between the spring force adjustment piece 33 and the first stage push-up member 21, and the second stage holding compression coil spring 36 is between the spring force adjustment piece 34 and the second stage push-up member 22. The spring force adjustment pieces 33 and 34 are mounted on the linking up-and-down moving shaft 30 so that they are movable up and down thereon, and they are also secured to the linking up-and-down moving shaft 30 by screws (not shown). In other words, by moving the spring force adjustment pieces 33 and 34 up and down on the linking up-and-down moving shaft 30 and then securing them by screws, the spring forces of the first stage holding compression coil spring 35 and the second stage holding compression coil spring 36 are be adjusted.

The manner of making adjustment of the amounts of rise of the first, second, and third stage push-up members 21, 22, and 23 will be described next.

The first stage stopper 24 is, as described above, screw-engaged with the first stage push-up member 21. Accordingly, by moving the first stage stopper 24 up and down, the interval H1 between the lower surface of the upper end of the suction stage 10 and the first stage stopper 24 is adjusted. This interval H1 is the first stage rising amount by which the first, second, and third stage push-up members 21, 22, and 23 is raised.

The nuts 27 that constitute the second stage stopper are screw-engaged with the stopper shaft 26. Accordingly, by moving the nuts 27 up and down, the interval H2 between the first stage push-up member 21 and the nuts 27 is adjusted. This interval H2 is the second stage rising amount by which the second stage and third stage push-up members 22 and 23 is raised further after the first stage push-up member 21 is raised. The amount of rise by which the linking up-and-down moving shaft 30 is made to rise further after the second stage and third stage push-up members 22 and 23 are raised for the second stage rising amount is the third stage rising amount of the third stage push-up member 23.

The structure of the up-and-down drive unit 40 will be described below.

In the suction stage support block 16 and in the portion directly below the linking up-and-down moving shaft 30, an up-and-down moving drive shaft 41 is installed so that it is rotatable by bearings 42. The upper end of the up-and-down moving drive shaft 41 is connected by a connecting piece 43 to the lower end of the linking up-and-down moving shaft 30. A support plate 44 is secured to the lower end of the up-and-down moving drive shaft 41. The support plate 44 contacts a roller 45 which is provided on a roller shaft 46 so that the roller 45 is rotatable. The roller shaft 46 is secured at one end of a lever 47, and the other end of the lever 47 is secured to a turning shaft 48. The turning shaft 48 is linked to the motor shaft of a motor (not shown). A spring holder 49 is secured to the support plate 44, and a coil spring 50 is fastened so that the support plate 44 is pressed against the roller 45.

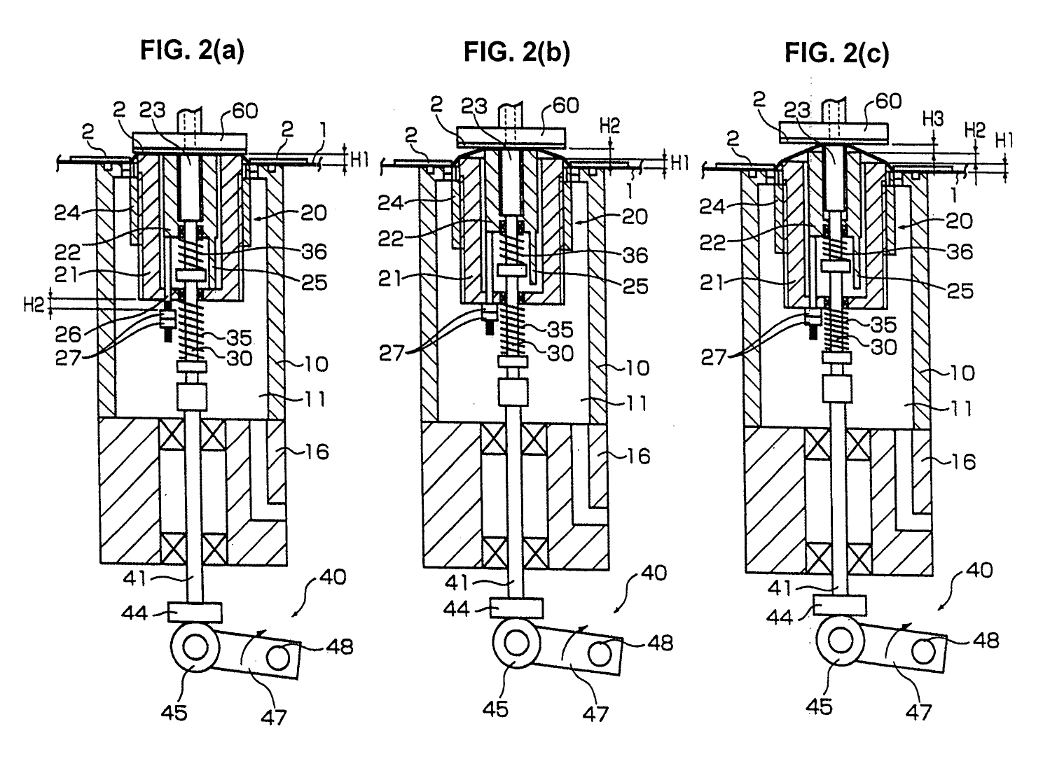

Next, the action of the die pickup apparatus described above will be described with reference to FIGS. 1(a) through FIG. 2(c).

As shown in FIG. 1(a), a wafer sheet 1 is placed on the suction stage 10; and at this point, the vacuum pump connected to the vacuum suction hole 17 is caused to operate. As a result, the wafer sheet 1 is suction-drawn and secured by the ring-shaped channel 14 and communicating channels 15 (see FIG. 1(b)) via the sheet suction holes 13.

Next, as shown in FIGS. 2(a), 2(b), and 2(c), the suction head 60 is lowered and comes into contact with the dies 2 and suction-holds the dies 2. The lever 47 is turned about the turning shaft 48 in the direction shown by arrow. As a result, the roller 45 lifts up the support plate 44, causing the up-and-down moving drive shaft 41 and the linking up-and-down moving shaft 30 to be raised.

More specifically, when the lever 47 is turned and the linking up-and-down moving shaft 30 is raised from the status shown in FIG. 1(a) to the status shown in FIG. 2(a), the first stage push-up member 21 is caused to rise by the spring force of the first stage holding compression coil spring 35. Together with the first stage push-up member 21, the first stage stopper 24 is raised by precisely the first stage rising amount H1 shown in FIG. 1(1), the first stage stopper 24 comes into contact with the lower surface of the upper end of the suction stage 10, and as a result the rising motion of the first stage push-up member 21 stops. Here, when the first stage push-up member 21 is raised, the second stage push-up member 22 is also raised together with the first stage push-up member 21, through the linking stopper 25. Furthermore, the third stage push-up member 23 is also raised together with the second stage push-up member 22. In other words, as shown in FIG. 2(a), the first, second, and third stage push-up members 21, 22, and 23 are raised by precisely the first stage rising amount H1 (see FIG. 1(a)). As a result, the outermost edges of a die that is a target to be picked up among the plurality of dies are peeled away from the wafer sheet 1.

When the lever 47 is turned further as shown in FIG. 2(b), the first stage push-up member 21 cannot be raised because the first stage stopper 24 is in contact with the suction stage 10, but the second stage push-up member 22, by the spring force of the second stage holding compression coil spring 36, is raised together with the third stage push-up member 23 until the nuts 27 come in contact with the bottom of the first stage push-up member 21. In other words, the second stage push-up member 22 and the third stage push-up member 23 are raised by precisely the second stage rising amount H2. As a result, the target die 2 at positions corresponding to the upper surface of the first stage push-up member 21 is further peeled away from the wafer sheet 1.

When the lever 47 is turned further as shown in FIG. 2(c), the second stage push-up member 22 cannot be raised because the nuts 27 are in contact with the bottom of the first stage push-up member 21; and as a result, only the third stage push-up member 23 is raised by the amount of rise of the linking up-and-down moving shaft 30. In other words, the third stage push-up member 23 is raised by precisely the third stage rising amount H3. As a result, the target die 2 at positions corresponding to the upper surface of the second stage push-up member 22 is further peeled away from the wafer sheet 1.

After this operation, the lever 47 is turned back in the opposite direction from that described above, and this brings the first, second and third stage push-up members 21, 22 and 23 to descend, and the wafer sheet push-up unit 20 assumes the initial state. The suction head 60 suction-holds the dies 2 and conveys them to a prescribed position.

As seen from the above, since the wafer sheet 1 is successively peeled away from the die from the outer circumferential side toward the center of the die, the peeling-away is done smoothly, without subjecting only some portion of the dies 2 to concentrated excessive stress. As a consequence, even a die that has a large surface area and is small in thickness can be picked up without breaking.

In the above-described embodiment, in particular, by moving the first stage stopper 24 up and down, the first stage rising amount H1 of the first stage push-up member 21 is adjusted; by moving the nuts 27 up and down, the second stage rising amount H2 of the second stage push-up member 22 is adjusted; and by controlling the amount of rise by which the third stage push-up member 23 is raised after the second stage push-up member 22 is raised for the second stage rising amount H2, the third stage rising amount H3 can be set. The rising amounts H1, H2, and H3 of the first, second, and third stage push-up members 21, 22, and 23 can be severally adjusted in this manner. Accordingly, for die size changes, wafer sheet changes, and variations over time, the rising amounts H1, H2, and H3 for each of the first, second, and third stage push-up members 21, 22, and 23 can, respectively, be adjusted to the optimal condition.

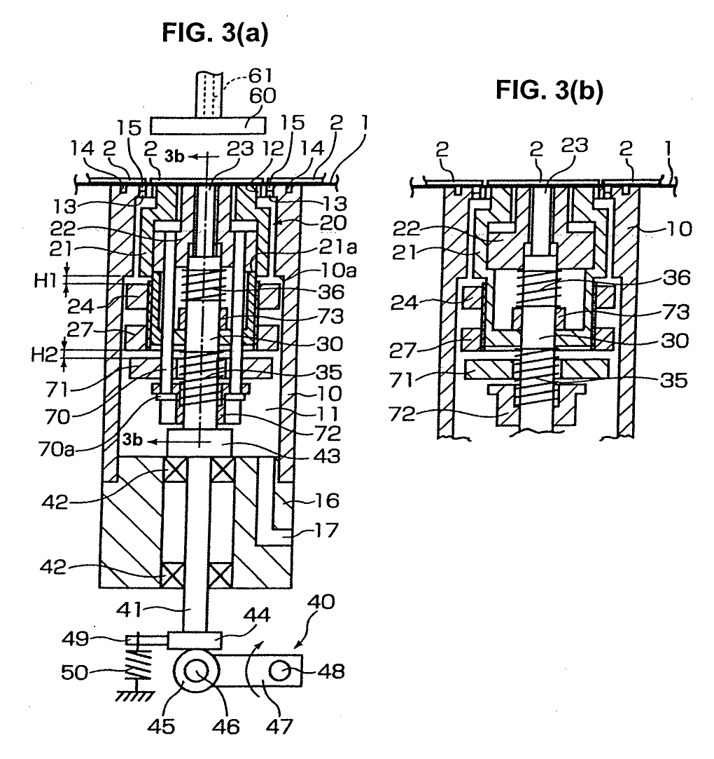

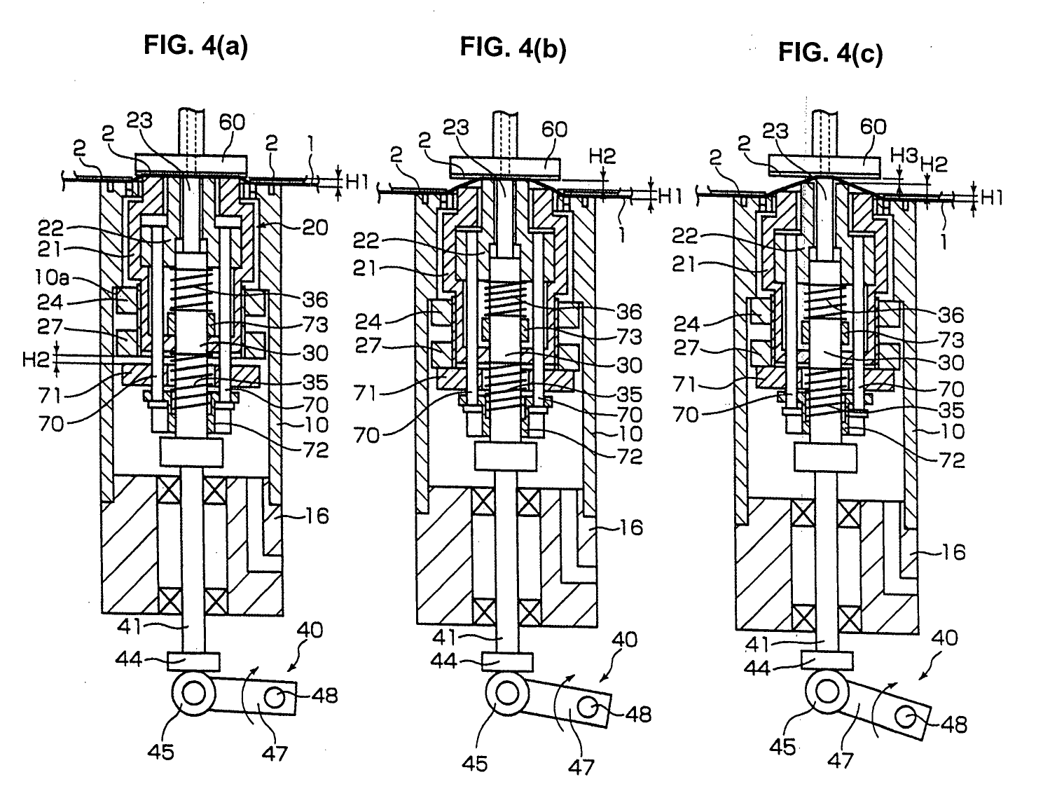

FIGS. 3(a) through 4(c) show another embodiment of the die pickup apparatus of the present invention.

In the following description, the same reference numerals are use for the members that are the same as or correspond to those of the above-described embodiment (of FIG. 1 (a) through FIG. 2(c)). The embodiment of FIGS. 3(a) through 4(c) differs from the above-described embodiment shown in FIG. 1(a) through FIG. 2(c) only in the structure of the wafer sheet push-up unit 20. In other words, the element given with the reference numerals 1 to 17, the up-and-down drive unit 40 and the suction head 60 are the same as those of the above-described embodiment shown in FIG. 1(a) through FIG. 2(c), and no further description on those structures will be provided below.

The structure of the wafer sheet push-up unit 20 will be described first.

The wafer sheet push-up unit 20, as in the above-described embodiment of FIG. 1(a) through FIG. 2(c), is provided in the empty space 11 inside the suction stage 10 so that the upper end of the wafer sheet push-up unit 20 is exposed from the push-up member opening 12 of the suction stage 10. The wafer sheet push-up unit 20 is comprised of a first stage push-up member 21, a second stage push-up member 22, and a third stage push-up member 23 that are disposed successively from the outer side to the inner side of the suction stage 10. In other words, the first stage push-up member 21 is inside the suction stage 10, the second stage push-up member 22 is inside the first stage push-up member 21, and the third stage push-up member 23 is inside the second stage push-up member 22. The top end surfaces and the horizontal cross sections of the first, second, and third stage push-up members 21, 22, and 23 are respectively formed in a square shape.

The first stage push-up member 21 is positioned outermost, and the vertical cross-section thereof is in a concavity shape. A first stage stopper 24 and a second stage stopper 27 are screwed into the outer circumference of the first stage push-up member 21. The first stage stopper 24 is provided in opposition to (or provided to positionally correspond to) an interior step 10a formed on the inner surface of the suction stage 10, while the second stage stopper 27 is provided at the lower end of the first stage push-up member 21.

The second stage push-up member 22 is carried on the step 21a, which is formed inside the concavity of the first stage push-up member 21, and is provided so as to be movable up and down in the first stage push-up member 21. The upper surface of the second stage push-up member 22 is set to be in the same plane as the upper surface of the first stage push-up member 21, when the bottom of the second stage push-up member 22 is in contact with (or is on) the step 21a of the first stage push-up member 21. More over, to the second stage push-up member 22, stopper supporting shafts 70 are secured which passes through the bottom surface of the first stage push-up member 21. The stopper supporting shafts 70 function both as a rotation arrester and as a second stage stopper supporting shaft. A second stage stopper supporting plate 71, formed in a ring shape, is secured to the stopper supporting shafts 70. Onto the lower portion of the stopper supporting shafts 70 is fitted a first stage compression coil spring holding block 72 so that it is movable up and down on the linking up-and-down moving shaft 30, and this first stage compression coil spring holding block 72 is supported by a collar 70a that is provided at the lower ends of the stopper supporting shafts 70.

The third stage push-up member 23 is provided so that it is movable up and down in the second stage push-up member 22; and to the bottom of this third stage push-up member 23, the linking up-and-down moving shaft 30 that extends downward and is secured to the connecting piece 43 is secured. The linking up-and-down moving shaft 30 passes through the bottom of the first stage push-up member 21 and is movable up and down in the first stage push-up member 21. The linking up-and-down moving shaft 30 is fitted loosely in the hollow part of the second stage stopper supporting plate 71, and the above-described first stage compression coil spring holding block 72 is secured to this linking up-and-down moving shaft 30. A positioning piece 73 is secured to the linking up-and-down moving shaft 30 so that the positioning piece 73 is at the portion above the bottom surface of the second stage push-up member 22; and the upper surface of the third stage push-up member 23 is formed so that it is in the same plane as the upper surfaces of the first and second stage push-up members 21 and 22 when the positioning piece 73 is in contact with the bottom surface of the first stage push-up member 21. On the linking up-and-down moving shaft 30, the first stage holding compression coil spring 35 and the second stage holding compression coil spring 36 are provided. The first stage holding compression coil spring 35 is located between the first stage compression coil spring holding block 72 and the bottom surface of the first stage push-up member 21, and the second stage holding compression coil spring 36 is located between the positioning piece 73 and the lower surface of the second stage push-up member 22.

Next, the manner of making adjustment of the amounts of rise of the first, second, and third stage push-up members 21, 22, and 23 will be described.

The first stage stopper 24 is screw-engaged with the first stage push-up member 21 so as to positionally correspond to the interior step 10a of the suction stage 10; accordingly, the interval H1 (see FIG. 3(a)) between the interior step 110a of the suction stage 10 and the first stage stopper 24 is adjusted by moving the first stage stopper 24 up and down. This interval H1 will be the first stage rising amount by which the first, second, and third stage push-up members 21, 22, and 23 are raised.

To the second stage push-up member 22, the second stage stopper supporting plate 71 is secured via the stopper supporting shafts 70; and positionally corresponding to the second stage stopper supporting plate 71, the second stage stopper 27 is screw-engaged with the first stage push-up member 21. Accordingly, by moving the second stage stopper 27 up and down, the interval H2 between the second stage stopper supporting plate 71 and the second stage stopper 27 is adjusted. This interval H2 will be the second stage rising amount by which the second stage and third stage push-up members 22 and 23 are raised further after the first stage push-up member 21 is raised.

The amount of rise by which the linking up-and-down moving shaft 30 is made to rise further, after the second stage rising of the second and third stage push-up members 22 and 23, will be the third stage rising amount of the third stage push-up member 23.

Next, the action of the die pickup apparatus described above will be described with reference to FIGS. 3(a) through FIG. 4(c).

As shown in FIGS. 3(a) and 3(b), a wafer sheet 1 is placed on the suction stage 10; and at this point, the vacuum pump connected to the vacuum suction hole 17 is caused to operate. As a result, the wafer sheet 1 is suction-drawn and secured by the ring-shaped channel 14 and communicating channels 15 (see FIG. 1(b)) via the sheet suction holes 13.

Next, as shown in FIG. 4(a), 4(b), and 4(c), the lever 47 is turned about the turning shaft 48 in the direction shown by arrow. As a result, the roller 45 lifts up the support plate 44, causing the up-and-down moving drive shaft 41 and the linking up-and-down moving shaft 30 to be raised.

More specifically, when the lever 47 turns and the linking up-and-down moving shaft 30 is raised from the status shown in FIG. 3(a) to the status shown in FIG. 4(a), the first stage push-up member 21 is caused to rise by the spring force of the first stage holding compression coil spring 35. Together with the first stage push-up member 21, the first stage stopper 24 is raised by precisely the first stage rising amount H1 shown in FIG. 3(a), the first stage stopper 24 comes into contact with the interior step 10a of the suction stage 10, and as a result, the rising motion of the first stage push-up member 21 is stopped. Here, when the first stage push-up member 21 is raised, the second stage push-up member 22 is also raised together with the first stage push-up member 21, due to the step 21a of the first stage push-up member 21. Furthermore, the third stage push-up member 23 is also raised together with the second stage push-up member 22. In other words, as shown in FIG. 4(a), the first, second, and third stage push-up members 21, 22, and 23 are raised by precisely the first stage rising amount H1. As a result, the outermost edges of a die that is a target to be picked up are peeled away from the wafer sheet 1.

When the lever 47 is turned further as shown in FIG. 4(b), the first stage push-up member 21 cannot be raised because the first stage stopper 24 is in contact with the suction stage 10, but the second stage push-up member 22, by the spring force of the second stage holding compression coil spring 36, is raised together with the third stage push-up member 23 until the second stage stopper supporting plate 71 comes into contact with the bottom of the second stage stopper 27. In other words, the second stage push-up member 22 and the third stage push-up member 23 are raised by precisely the second stage rising amount H2. As a result, the target die 2 at positions corresponding to the upper surface of the first stage push-up member 21 is further peeled away from the wafer sheet 1.

As shown in FIG. 4(c), when the lever 47 is further turned, the second stage push-up member 22 cannot be raised because the second stage stopper supporting plate 71 is in contact with the second stage stopper 27; and as a result, only the third stage push-up member 23 is raised by the amount of rise of the linking up-and-down moving shaft 30. In other words, the third stage push-up member 23 is raised by precisely the third stage rising amount H3. As a result, the target die 2 at positions corresponding to the upper surface of the second stage push-up member 22 is further peeled away from the wafer sheet 1.

After this operation, the lever 47 is turned back in the opposite direction from that described above, and this brings the first, second, and third stage push-up members 21, 22, and 23 to descend and the wafer sheet push-up unit 20 assumes the initial condition. The suction head 60 suction-holds the dies 2 and conveys them to a prescribed position.

As seen from the above, in the above embodiment shown in FIGS. 3(a) through 4(c) as well, as in the embodiment shown in FIGS. 1(a) through 2(c), the wafer sheet 1 is successively peeled away from the die from the outer circumferential side toward the center of the die. Accordingly, the wafer sheet peeling-away is done smoothly, without subjecting only some portion of the die 2 to concentrated excessive stress. As a result, even a die that has a large surface area and is small in thickness can be picked up without breaking after being separated from a wafer sheet.

Moreover, in the above-described embodiment of FIGS. 3(a) through 4(c), by moving the first stage stopper 24 up and down, the first stage rising amount H1 of the first stage push-up member 21 is adjusted; by moving the second stage stopper 27 up and down, the second stage rising amount H2 of the second stage push-up member 22 is adjusted; and by controlling the amount of rise by which the third stage push-up member 23 is raised after the second stage push-up member 22 is raised for the second stage rising amount H2, the third stage rising amount H3 can be set. The rising amounts H1, H2, and H3 of the first, second, and third stage push-up members 21, 22, and 23 can be severally adjusted in this manner. Accordingly, for die size changes, wafer sheet changes, and variations over time, the rising amounts H1, H2, and H3 for each of the first, second, and third stage push-up members 21, 22, and 23 can, respectively, be adjusted to the optimal condition.

In the above-described embodiments of the present invention, three first stage push-up members 21, 22, and 23 are provided. However, the present invention is applicable also to the structure in which four or more push-up members are provided. Moreover, the above descriptions are for the structures in which the surfaces and cross-sections of the first, second, and third stage push-up members 21, 22, and 23 are formed in square shapes. However, the first, second, and third stage push-up members 21, 22, and 23 are not limited to square shapes, and rectangular shapes, circular (ring) shapes, elliptical shapes and the like can be indeed employed in the present invention.

1. A die pickup apparatus comprising:
a suction stage for suction-holding a lower surface of a wafer sheet having dies lined up and affixed thereon;
a wafer sheet push-up unit provided inside said suction stage, said wafer sheet push-up unit including a plurality of push-up members disposed successively from outer side to inner side of said suction stage;
an up-and-down drive unit for driving said wafer sheet push-up unit in a direction of up and down, said up-and-down drive unit having an up-and-down moving drive shaft;
an outermost push-up stopper being screwed into an outer circumference of an outermost push-up member of said push-up members;
a step for contacting said outermost push-up stopper to said suction stage to stop rising motion of said outermost push-up member, being provided opposite to said outermost push-up stopper on an inner surface of said suction stage; and
a plurality of intermediate push-up stoppers for contacting each one of said push-up members located immediately outside each one of a plurality of intermediate push-up members to stop rising motion of each one of said intermediate push-up members, being provided adjustably in an up-and-down position on said intermediate push-up members disposed between said outermost push-up member and an innermost push-up member of said push-up members.

2. The die pickup apparatus according to claim 1, wherein said innermost push-up member of said push-up members is linked to said up-and-down moving drive shaft for driving in a direction of up and down by said up-and-down drive unit.

3. The die pickup apparatus according to claim 1, wherein, after raising simultaneously all of said push-up members by raising said up-and-down moving drive shaft, next, sequentially further raising said push-up members from one of said push-up members located immediately inside said outermost push-up member to said innermost push-up member, thus said wafer sheet is peeled away successively from a die from an outer circumferential side of said die toward a center of said die by means of said push-up members.

4. The die pickup apparatus according to claim 1, wherein a plurality of die pressing surfaces of all of said push-up members are ring-shaped, said die pressing surfaces being on top ends of said push-up members.

5. A die pickup method using a die pickup apparatus, comprising:
providing a die pickup apparatus, the die pickup apparatus comprising:
a suction stage for suction-holding a lower surface of a wafer sheet having dies lined up and affixed thereon,
a wafer sheet push-up unit provided inside said suction stage, said wafer sheet push-up unit including a plurality of push-up members disposed successively from outer side to inner side of said suction stage,
an up-and-down drive unit for driving said wafer sheet push-up unit in a direction of up and down, said up-and-down drive unit having an up-and-down moving drive shaft,
an outermost push-up stopper being screwed into an outer circumference of an outermost push-up member of said push-up members,
a step for contacting said outermost push-up stopper to said suction stage to stop rising motion of said outermost push-up member, being provided opposite to said outermost push-up stopper on an inner surface of said suction stage, and
a plurality of intermediate push-up stoppers for contacting each one of said push-up members located immediately outside each one of a plurality of intermediate push-up members to stop rising motion of each one of said intermediate push-up members, being provided adjustably in an up-and-down position on said intermediate push-up members disposed between said outermost push-up member and an innermost push-up member of said push-up members;
linking said innermost push-up member of said push-up members to said up-and-down moving drive shaft;
simultaneously raising all of said push-up members by raising said up-and-down moving drive shaft; and then
sequentially further raising said push-up members from one of said push-up members located immediately inside said outermost push-up member to said innermost push-up member, thus said wafer sheet being peeled away successively from a die from an outer circumferential side of said die toward a center of said die by means of said push-up members.

6. The die pickup method using a die pickup apparatus according to claim 5, wherein said die is suction-held by a suction head, after peeling away said wafer sheet.

7. A die pickup method comprising the step of:
providing a suction stage for suction-holding a lower surface of a wafer sheet having dies lined up and affixed thereon;
providing a wafer sheet push-up unit disposed inside said suction stage, said wafer sheet push-up unit including a plurality of push-up members disposed successively from outer side to inner side of said suction stage;
providing an up-and-down drive unit for driving said wafer sheet push-up unit in a direction of up and down, said up-and-down drive unit having an up-and-down moving drive shaft;
providing an outermost push-up stopper being screwed into an outer circumference of an outermost push-up member of said push-up members;
providing a step for contacting said outermost push-up stopper to said suction stage to stop rising motion of said outermost push-up member, being disposed opposite to said outermost push-up stopper on an inner surface of said suction stage;
providing a plurality of intermediate push-up stoppers for contacting each one of said push-up members located immediately outside each one of a plurality of intermediate push-up members to stop rising motion of each one of said intermediate push-up members, being disposed adjustably in an up-and-down position on said intermediate push-up members disposed between said outermost push-up member and an innermost push-up member of said plurality of push-up members;
linking said innermost push-up member of said push-up members to said up-and-down moving drive shaft;
simultaneously raising all of said push-up members by raising said up-and-down moving drive shaft; and then
sequentially further raising said push-up members from one of said push-up members located immediately inside said outermost push-up member to said innermost push-up member, thus said wafer sheet being peeled away successively from a die from an outer circumferential side of said die toward a center of said die by means of said push-up members.

8. The die pickup method according to claim 7, wherein said die is suction-held by a suction head, after peeling away said wafer sheet.

9. A die pickup apparatus comprising:
a suction stage for suction-holding a lower surface of a wafer sheet having dies lined up and affixed thereon;
a wafer sheet push-up unit provided inside said suction stage, said wafer sheet push-up unit including three push-up members having a first stage push-up member, a second stage push-up member, and a third stage push-up member, disposed successively from outer side to inner side of said suction stage;
an up-and-down drive unit for driving said wafer sheet push-up unit in a direction of up and down, said up-and-down drive unit having an up-and-down moving drive shaft;
a first stage stopper for contacting an outer circumference of said first stage push-up member to said suction stage to stop rising motion of said first stage push-up member, being provided adjustably in an up-and-down position on said first stage push-up members;
a linking stopper disposed between a bottom surface of said second stage push-up member and an inner bottom surface of said first stage push-up member, and for maintaining a space therebetween;
a stopper shaft provided on a bottom of said second stage push-up member by passing through a bottom of said first stage push-up member;
a second stage stopper for stopping rising motion of said second stage push-up member, being provided adjustably in an up-and-down position on said stopper shaft;
a linking up-and-down moving shaft being secured to said third stage push-up member, extending downward through said second stage push-up member and said first stage push-up member, and being linked to said up-and-down moving drive shaft;
a first stage holding compression spring being provided on a lower surface side of said first stage push-up member, for biasing power against said first stage push-up member upward; and
a second stage holding compression spring being disposed in a space between said first stage push-up member and said second stage push-up member, for biasing power against said second stage push-up member upward.

10. The die pickup apparatus according to claim 9, wherein, after raising simultaneously all of said push-up members by raising said up-and-down moving drive shaft, next, sequentially further raising said second stage push-up member and said third stage push-up member, lastly, raising said third stage push-up member, thus said wafer sheet is peeled away successively from a die from an outer circumferential side of said die toward a center of said die by means of said push-up members.

11. The die pickup apparatus according to claim 9, wherein a plurality of die pressing surfaces of all of said push-up members are ring-shaped, said die pressing surfaces being on top ends of said push-up members.

12. A die pickup method using a die pickup apparatus, comprising:
providing a die pickup apparatus, the die pickup apparatus comprising:
a suction stage for suction-holding a lower surface of a wafer sheet having dies lined up and affixed thereon,
a wafer sheet push-up unit provided inside said suction stage, said wafer sheet push-up unit including three push-up members having a first stage push-up member, a second stage push-up member, and a third stage push-up member, disposed successively from outer side to inner side of said suction stage,
an up-and-down drive unit for driving said wafer sheet push-up unit in a direction of up and down, said up-and-down drive unit having an up-and-down moving drive shaft,
a first stage stopper for contacting an outer circumference of said first stage push-up member to said suction stage to stop rising motion of said first stage push-up member, being provided adjustably in an up-and-down position on said first stage push-up member;
a linking stopper disposed between a bottom surface of said second stage push-up member and an inner bottom surface of said first stage push-up member, and for maintaining a space therebetween,
a stopper shaft provided on a bottom of said second stage push-up member by passing through a bottom of said first stage push-up member,
a second stage stopper for stopping rising motion of said second stage push-up member, being provided adjustably in an up-and-down position on said stopper shaft,
a linking up-and-down moving shaft being secured to said third stage push-up member, extending downward through said second stage push-up member and said first stage push-up member, and being linked to said up-and-down moving drive shaft,
a first stage holding compression spring being provided on a lower surface side of said first stage push-up member, for biasing power against said first stage push-up member upward, and
a second stage holding compression spring being disposed in a space between said first stage push-up member and said second stage push-up member, for biasing power against said second stage push-up member upward;
linking said third stage push-up member to said up-and-down moving drive shaft;
simultaneously raising all of said push-up members by raising said up-and-down moving drive shaft;
sequentially further raising said second stage push-up member and said third stage push-up member; and
lastly further raising said third stage push-up member, thus said wafer sheet being peeled away successively from a die from an outer circumferential side of said die toward a center of said die by means of said push-up members.

13. The die pickup method using a die pickup apparatus according to claim 12, wherein said die is suction-held by a suction head, after peeling away said wafer sheet.

14. A die pickup method comprising the steps of:
providing a suction stage for suction-holding a lower surface of a wafer sheet having dies lined up and affixed thereon;
providing a wafer sheet push-up unit installed inside said suction stage, said wafer sheet push-up unit including three push-up members having a first stage push-up member, a second stage push-up member, and a third stage push-up member, disposed successively from outer side to inner side of said suction stage;
providing an up-and-down drive unit for driving said wafer sheet push-up unit in a direction of up and down, said up-and-down drive unit having an up-and-down moving drive shaft;
providing a first stage stopper for contacting an outer circumference of said first stage push-up member to said suction stage to stop rising motion of said first stage push-up member, being disposed adjustably in an up-and-down position on said first stage push-up member;
providing a linking stopper disposed between a bottom surface of said second stage push-up member and an inner bottom surface of said first stage push-up member, and for maintaining a space therebetween;
providing a stopper shaft provided on a bottom of said second stage push-up member by passing through a bottom of said first stage push-up member;
providing a second stage stopper for stopping rising motion of said second stage push-up member, being provided adjustably in an up-and-down position on said stopper shaft,
providing a linking up-and-down moving shaft being secured to said third stage push-up member, extending downward through said second stage push-up member and said first stage push-up member, and being linked to said up-and-down moving drive shaft;
providing a first stage holding compression spring being disposed on a lower surface side of said first stage push-up member, for biasing power against said first stage push-up member upward;
providing a second stage holding compression spring being disposed in a space between said first stage push-up member and said second stage push-up member and for biasing power against said second stage push-up member upward;
linking said third stage push-up member to said up-and-down moving drive shaft;
simultaneously raising all of said push-up members by raising said up-and-down moving drive shaft;
sequentially further raising said second stage push-up member and said third stage push-up member; and
lastly further raising said third stage push-up member, thus said wafer sheet being peeled away successively from a die from an outer circumferential side of said die toward a center of said die by means of said push-up members.

15. The die pickup method according to claim 14, wherein said die is suction-held by a suction head, after peeling away said wafer sheet.

16. A die pickup apparatus comprising:
a suction stage for suction-holding a lower surface of a wafer sheet having dies lined up and affixed thereon;
a wafer sheet push-up unit provided inside said suction stage, said wafer sheet push-up unit including three push-up members having a first stage push-up member, a second stage push-up member, and a third stage push-up member, disposed successively from outer side to inner side of said suction stage;
an up-and-down drive unit for driving said wafer sheet push-up unit in a direction of up and down, said up-and-down drive unit having an up-and-down moving drive shaft;
a first stage stopper for contacting an outer circumference of said first stage push-up member to said suction stage to stop rising motion of said first stage push-up member, being provided adjustably in an up-and-down position on said first stage push-up member;
a stopper supporting shaft for passing through said first stage push-up member, being secured to said second stage push-up member;
a ring-shaped second stage stopper supporting plate being secured to said stopper supporting shaft;
a second stage stopper for contacting said second stage stopper supporting plate to stop rising motion of said second push-up member, being provided adjustably in an up-and-down position on said first stage push-up member and being also provided relative to said second stage stopper supporting plate;
a first stage compression spring holding block being provided movably in a direction of up and down with supporting said stopper supporting shaft on a lower end thereof;
a linking up-and-down moving shaft being secured to said third stage push-up member, said linking up-and-down moving shaft extending downward through said first stage push-up member, and being linked to said up-and-down moving drive shaft;
a positioning piece being secured to said linking up-and-down moving shaft and being provided in a portion on a bottom surface of said first stage push-up member;
a first stage holding compression spring being provided between said first stage compression spring holding block and said first stage push-up member, for biasing power against said first stage push-up member upward; and
a second stage holding compression spring being provided between said positioning piece and said second stage push-up member, for biasing power against said second stage push-up member upward.

17. The die pickup apparatus according to claim 16, wherein, after raising simultaneously all of said push-up members by raising said up-and-down moving drive shaft, next, sequentially further raising said second stage push-up member and said third stage push-up member, lastly, further raising said third stage push-up member, thus said wafer sheet is peeled away successively from a die from an outer circumferential side of said die toward a center of said die by means of said push-up members.

18. The die pickup apparatus according to claim 16, wherein a plurality of die pressing surfaces of all of said push-up members are ring-shaped, said die pressing surfaces being on top ends of said push-up members.

19. The die pickup apparatus according to claim 16, wherein said second stage push-up member is set on a step formed inside said first stage push-up member and is provided movably in a direction of up and down inside said first stage push-up member.

20. A die pickup method using a die pickup apparatus, comprising:
providing a die pickup apparatus, the die pickup apparatus comprising:
a suction stage for suction-holding a lower surface of a wafer sheet having dies lined up and affixed thereon,
a wafer sheet push-up unit provided inside said suction stage, said wafer sheet push-up unit including three push-up members having a first stage push-up member, a second stage push-up member, and a third stage push-up member, disposed successively from outer side to inner side of said suction stage,
an up-and-down drive unit for driving said wafer sheet push-up unit in a direction of up and down, said up-and-down drive unit having an up-and-down moving drive shaft,
a first stage stopper for contacting an outer circumference of said first stage push-up member to said suction stage to stop rising motion of said first stage push-up member, said first stage stopper being provided adjustably in an up-and-down position on said first stage push-up member,
a stopper supporting shaft for passing through said first stage push-up member, being secured to said second stage push-up member,
a ring-shaped second stage stopper supporting plate being secured to said stopper supporting shaft,
a second stage stopper for contacting said second stage stopper supporting plate to stop rising motion of said second stage push-up member, being provided adjustably in an up-and-down position on said first stage push-up member and being also disposed relative to said second stage stopper supporting plate,
a first stage compression spring holding block being provided movably in a direction of up and down with supporting said stopper supporting shaft on a lower end thereof,
a linking up-and-down moving shaft being secured to said third stage push-up member, said linking up-and-down moving shaft extending downward through said first stage push-up member, and being linked to said up-and-down moving drive shaft,
a positioning piece being secured to said linking up-and-down moving shaft and being provided in a portion on a bottom surface of said first stage push-up member,
a first stage holding compression spring being provided between said first stage compression spring holding block and said first stage push-up member, for biasing power against said first stage push-up member upward, and
a second stage holding compression spring being provided between said positioning piece and said second stage push-up member, for biasing power against said second stage push-up member upward;
linking said third stage push-up member to said up-and-down moving drive shaft;
simultaneously raising all of said push-up members by raising said up-and-down moving drive shaft;
sequentially further raising said second stage push-up member and said third stage push-up member; and
lastly further raising said third stage push-up member, thus said wafer sheet being peeled away successively from a die from an outer circumferential side of said die toward a center of said die by means of said push-up members.

21. The die pickup method using a die pickup apparatus according to claim 20, wherein said die is suction-held by a suction head, after peeling away said wafer sheet.

22. A die pickup method comprising the step of:
providing a suction stage for suction-holding a lower surface of a wafer sheet having dies lined up and affixed thereon;
providing a wafer sheet push-up unit installed inside said suction stage, said wafer sheet push-up unit including three push-up members having a first stage push-up member, a second stage push-up member, and a third stage push-up member, disposed successively from outer side to inner side of said suction stage;
providing an up-and-down drive unit for driving said wafer sheet push-up unit in a direction of up and down, said up-and-down drive unit having an up-and-down moving drive shaft;
providing a first stage stopper for contacting an outer circumference of said first stage push-up member to said suction stage to stop rising motion of said first stage push-up member, said first stage stopper being disposed adjustably in an up-and-down position on said first stage push-up member;
providing a stopper supporting shaft for passing through said first stage push-up member, being secured to said second stage push-up member;
providing a ring-shaped second stage stopper supporting plate being secured to said stopper supporting shaft;
providing a second stage stopper for contacting said second stage stopper supporting plate to stop rising motion of said second stage push-up member, being disposed adjustably in an up-and-down position on said first stage push-up member and being also disposed relative to said second stage stopper supporting plate;
providing a first stage compression spring holding block being disposed movably in a direction of up and down with supporting said stopper supporting shaft on a lower end thereof;
providing a linking up-and-down moving shaft being secured to said third stage push-up member, said linking up-and-down moving shaft extending downward through said first stage push-up member, and being linked to said up-and-down moving drive shaft;
providing a positioning piece being secured to said linking up-and-down moving shaft and being provided in a portion on a bottom surface of said first stage push-up member;
providing a first stage holding compression spring being provided between said first stage compression spring holding block and said first stage push-up member, said first stage holding compression spring for biasing power against said first stage push-up member upward;
providing a second stage holding compression spring disposed between said positioning piece and said second stage push-up member, said second stage holding compression spring for biasing power against said second stage push-up member upward;
linking said third stage push-up member to said up-and-down moving drive shaft;
simultaneously raising all of said push-up members by raising said up-and-down moving drive shaft;
sequentially further raising said second stage push-up member and said third stage push-up member; and
lastly further raising said third stage push-up member, thus said wafer sheet being peeled away successively from a die from an outer circumferential side of said die toward a center of said die by means of said push-up members.

23. The die pickup method using a die pickup apparatus according to claim 22, wherein said die is suction-held by a suction head, after peeling away said wafer sheet.
